(19) United States
(12) Patent Application Publication
(10) Pub. No.: US 2008/0259479 A1
(43) Pub. Date: Oct. 23, 2008

(54) System and Methods for Copying Digital Information from a Digital Media

(75) Inventor: Nils Graef, Santa Clara, CA (US)

Correspondence Address: Hamilton,DeSanctis & Cha, 8555 W. BELLEVIEW AVE. G21-139, LITTLETON, CO, 80123, US

(73) Assignee: LSI Corporation, Milipitas, CA (US)

(21) Appl. No.: 11/738,633

(22) Filed: Apr. 23, 2007

(51) Int. Cl. G11B 5/86

(52) U.S. Cl. 360/15

(57) ABSTRACT

System and Methods for Copying Digital Information from a Digital Media Various embodiments of the present invention provide systems and methods for copying or ripping digital information contained on one media to another media. In particular, some embodiments of the present invention provide methods and systems for copying digital information contained in a first fixed media onto another media by using digital information content corresponding to that maintained on the first fixed media, but obtained from a database.

### BACKGROUND OF THE INVENTION

The present invention is related to systems and methods for copying or ripping digital information contained in one media onto another media. In particular, the present invention relates to methods and systems for copying digital information contained on a first fixed media onto another media using the digital information obtained from a database.

Ripping is the process of copying the audio or video data from one media form, such as digital versatile disc (DVD), including Blu Ray DVD, or compact disc (CD) to another media, such as hard disk, CD, flash memory, or the like. Ripping is often used to copy a collection of CDs or DVDs onto a portable media player such as the iPod. In most cases, the process of ripping is legal and acceptable. As a particular example, the iTunes software can automatically perform ripping of CDs (or “importing”) when a new CD is inserted into the computer.

While the process of ripping is generally known in the art, it is often cumbersome and difficult. For example, ripping multiple CDs or DVDs may be considered inconvenient as it requires waiting until the entire audio/video data has been read from the disk. Once the entire object is available, any desired format conversion is then applied. This approach can be time consuming. Some ripping software even reads the same object multiple times and performs error correction using a comparison between the reads. This, of course, makes the ripping process even more time consuming. Another problem with conventional ripping of CDs or DVDs is that scratches or defects on the disk can not be corrected and will be copied onto the new media. This renders the new media imperfect.

Hence, for at least the aforementioned reasons, there exists a need in the art for advanced systems and methods for copying digital information content of a fixed media onto another media.

### BRIEF SUMMARY OF THE INVENTION

The present invention is related to systems and methods for copying or ripping digital information contained in one media onto another media. In particular, the present invention relates to methods and systems for copying digital information contained on a first fixed media onto another media using the digital information obtained from a database.

Various embodiments of the invention provide methods for ripping or copying digital information contained in one fixed media onto another media. Such methods include using a portion of the digital information contained in the first fixed media to determine its digital information content, and writing or affixing the digital information content of the first fixed media onto another media. The digital information content of the first fixed media to be written or copied onto the other media is obtained from a database rather than from the first fixed media itself.

In some instances, the digital information content of the first fixed media is copied onto the other media after obtaining the entire digital information content of the first fixed media from the database.

In other instances, the process of obtaining the digital information content of the first fixed media from the database and writing the obtained digital information onto the other media is repeated until the entire digital information content of the first fixed media has been copied onto the other media.

Still in other instances, obtaining the digital information content of the first fixed media from the database and writing the digital information content onto the other media are performed concurrently.

Some instances of the invention include accessing an Internet website tailored for identifying the contents of the first fixed media using a portion of the digital information contained in the first fixed media. For example, for audio CDs methods of the invention can include accessing the compact disk database (CDDB) or using the CD-Text standard to determine the contents of the first fixed media.

Other aspects of the invention provide computer readable media that include instructions executable by a computer to copy the digital information content of a first fixed media onto a second media. The instructions are also executable to read or obtain a portion of the digital information from the first fixed media to determine the digital information contents of the first fixed media. In addition, the instructions are also executable to obtain substantially all of the digital information content of the first media from a database.

Yet other aspects of the invention provide systems for ripping digital information content of a first fixed media onto another media. Such systems include a computer and a computer readable medium accessible to the computer and including instructions executable by the computer to: obtain a portion of the digital information contained in a first fixed media and to determine the digital information content of the first fixed media; obtain the digital information content corresponding to the first fixed media from a database; and to render the digital information content obtained from the first fixed media onto the second fixed media using the digital information obtained from the database.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a flow diagram depicting a method in accordance with some embodiments of the invention for methods and systems for rendering a copy of digital information of one fixed media onto another media in accordance with various embodiments of the invention;

FIG. 2 depicts a system for methods and systems for rendering digital information of one fixed media onto another media in accordance with one or more embodiments of the invention; and

FIG. 3 is a flow diagram depicting a method in accordance with other embodiments of the invention for methods and systems for ripping or copying digital information of one fixed media to another media using a third party media source in accordance with various embodiments of the invention.

### DETAILED DESCRIPTION OF THE INVENTION

The present invention is related to systems and methods for copying or ripping digital information contained in one media onto another media. In particular, the present invention relates to methods and systems for copying digital information contained on a first fixed media onto another media using the digital information obtained from a database.

Various embodiments in accordance with the present invention for making a copy of digital information maintained on one digital medium to another digital medium through use of one or more generally accessible databases of digital information. Examples of the aforementioned embodiments are depicted in the included drawings and associated discussion. It should be noted that the included figures and associated discussion is provided for the purpose of illustrating the practice of the invention and do not constitute limitations on the scope of the invention.

One or more embodiments of the present invention provides for copying or ripping information from a fixed media to another media. As used herein, the phrase “fixed media” or “fixed medium” is used in its broadest sense to mean any media or medium that is not generally changeable once fixed. Thus, for example, a fixed medium may be, but is not limited to, a CD ROM, a DVD, a solid state memory, a Blu Ray DVD, a hard disk drive, a holographic memory device, and combinations of the aforementioned. It should be noted that CD ROMs and DVDs that are rewritable are included as fixed media as they are generally fixed once written and are not typically rewritten at the frequency that that a hard disk drive or random access memory would be re-written. Further, it should be noted that the other media onto which information maintained on the fixed media is to be rendered may be a fixed media or non-fixed media. Thus, for example, the other medium may be, but is not limited to, a CD ROM, a DVD, a solid state memory, a Blu Ray DVD, a hard disk drive, a holographic memory device, and combinations of the aforementioned. Ripping or copying in accordance with the aforementioned various embodiments includes using a portion of the digital information contained in the first fixed media to determine its digital information content, and writing or affixing the digital information content of the first fixed media onto another media. The digital information content of the first fixed media to be written or copied onto the other media is obtained from a database rather than from the first fixed media itself. Thus, rather than acting as the source of the information to be copied as is the case in a convention ripping or copying operation, the first fixed media operates somewhat like a license allowing an owner of the first fixed media to access another copy of the information on the first fixed media maintained apart from the first fixed media. As just some advantages of the aforementioned embodiments, errors on the first fixed media are not propagated onto the media receiving the copy, and the time required to perform a copying or ripping process may be greatly reduced.

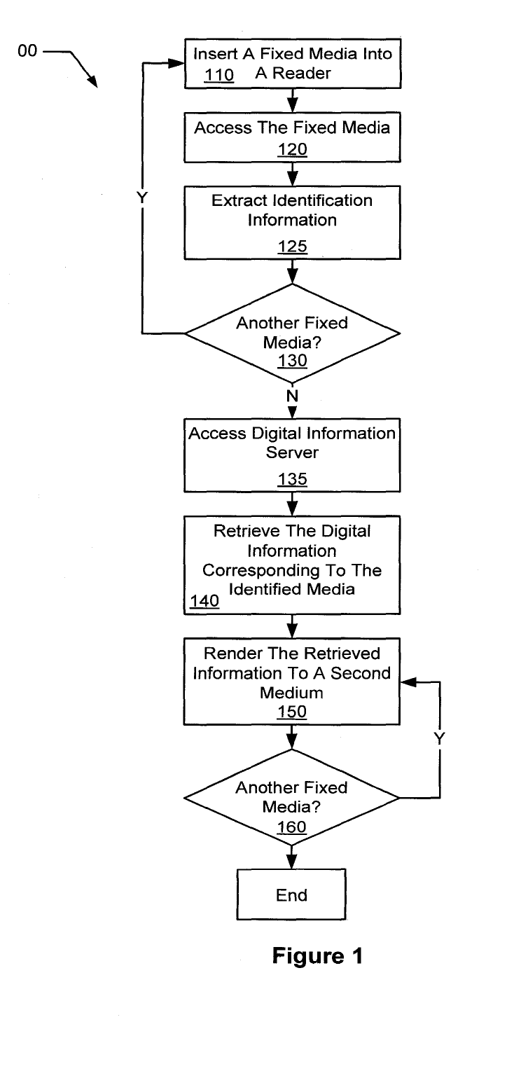

Turning to FIG. 1, a flow diagram 100 depicts a method in accordance with some embodiments of the invention for rendering a copy of digital information of one fixed media onto another media in accordance with various embodiments of the invention. As used herein, the term “rendering” is used in its broadest sense to mean affixing a set of digital information on a storage medium. Such a storage medium may be, but is not limited to, a CD, a DVD, a solid state memory, a Blu Ray DVD, a hard disk drive, a holographic memory device, and combinations of the aforementioned. The aforementioned solid state memory may include, but is not limited to, a static random access memory, a dynamic random access memory, an electronically erasable read only memory, a flash memory, and combinations of the aforementioned. Based on the disclosure provided herein, one of ordinary skill in the art will recognize a variety of media that may be used in relation to various embodiments of the present invention.

Following flow diagram 100, a first fixed media including digital information that is to be rendered to another media is inserted into a media reader by a user (block 110). In some embodiments of the present invention, the first fixed media is a CD or DVD. In such embodiments, the media reader may be a CD/DVD ROM drive. Where other types of fixed media are utilized, a media reader corresponding to the particular media type would be used. Systems and methods of the invention then read a portion of the digital information contained in the first fixed media (block 120). The portion of accessed information is parsed to extract identification information about the first fixed media (block 125). Where, for example, the first fixed media is a music CD, the identification information may include the title and artist(s) of the music CD. As another example, where the first fixed media is a movie DVD, the title of the identification may include the title of the movie. It should be noted that other types of media and corresponding identification information may be used in accordance with one or more embodiments of the present invention. In some embodiments of the present invention, the information read includes only enough information to identify the first fixed media. Thus, in the aforementioned music CD example, the music tracks would not necessarily be read. Where the identification information is insufficient, additional information on the first fixed media may be accessed.

Once the identification information is obtained from the first fixed media (block 125), it is determined whether another fixed media is to be rendered on another media (block 130). Where another fixed media is to be rendered (block 130), the processes of blocks 110-125 are repeated until all of the desired fixed media have been identified. Alternatively, where no further fixed media are to be rendered (block 130), the identified information is used to access a digital information server that includes the digital information corresponding to that of the identified digital media (block 135). Thus, for example, where the identified media is a music CD, the accessed server may be a music server that includes the music tracks corresponding to the identified music CD. In some cases, the appropriate information may be accessed using a compact disk database (i.e., CDDB) or by using the CD-Text standard. Identifying the CD using the CDDB in some instances involves calculating a substantially unique identification, for example, based on the track duration information stored in the table-of-contents of the CD, and then comparing the information with the CDDB. It should be appreciated that any suitable methods that can determine the identity and/or the contents of the first fixed media can be used to determine the digital information content of the first fixed media. Alternatively, where the identified media is a movie DVD, the accessed server may be a movie server that includes the movie corresponding to the identified movie DVD. There are numerous databases, including commercial databases, available for retrieving the digital information of the first fixed media. Some of the representative commercial databases available for retrieving, e.g., downloading, audio or video information include, but are not limited to, iTunes®, Napster®, Rhapsody®, as well as others. Alternatively, audio or video information can be retrieved using a peer-to-peer file sharing program to locate a database that contain the digital information of the first fixed media. Based on the disclosure provided herein, one of ordinary skill in the art will recognize a variety of other media and corresponding digital information servers that may be used in accordance with one or more embodiments of the present invention.

Once the server including the identified digital information is accessed (block 135), the digital information corresponding to the identified fixed media is accessed from the server (block 140), and the retrieved information is rendered to another medium (block 150). This may include, for example, writing the retrieved information to a CD, a DVD, a hard disk drive, or another desired medium. In some embodiments of the present invention, where multiple fixed media are to be “copied”, they may be copied to corresponding multiple media. In this case, it is determined if multiple fixed media have been identified. Where such is the case and another fixed media is to be rendered (block 160), a user is prompted to insert another fixed media and retrieved data corresponding to that fixed media is written thereto the newly inserted fixed media (block 150). Where no other fixed media is to be rendered (block 130), the process ends.

In other embodiments of the present invention, the digital information associated with more than one identified media are to be written to one single media. In such cases, the process of block 160 is not needed. Rather, in block 150, the media is written with all of the identified digital information. This may be the case, for example, where a memory of a digital music player is to be written with a number of tracks corresponding to multiple music CDs. Based on the disclosure provided herein, one of ordinary skill in the art will recognize a number of other situations where the digital information corresponding to multiple fixed media are to be rendered to a selected medium.

Based on the disclosure provided herein, one of ordinary skill in the art will recognize a variety of advantages that may be achieved using one or more embodiments of the present invention. For example, one or more embodiments of the present invention avoid scenarios where defects on a media to be copied end up getting copied to another media. Such defects may include, but are not limited to, scratches and/or manufacturing defects that may be present on the first fixed media. As another exemplary advantage, the time required in the previous process of “copying” or “ripping” may be reduced as only identification information need be extracted from a given fixed media. It should be noted, that the fixed media may further include authentication information to assure that the media being copied is an original and thus qualifying for rights to access the server providing the retrieved information. Based on the disclosure provided herein, one of ordinary skill in the art will recognize a myriad of advantages that may be had through use of systems and methods in accordance with various embodiments of the present invention.

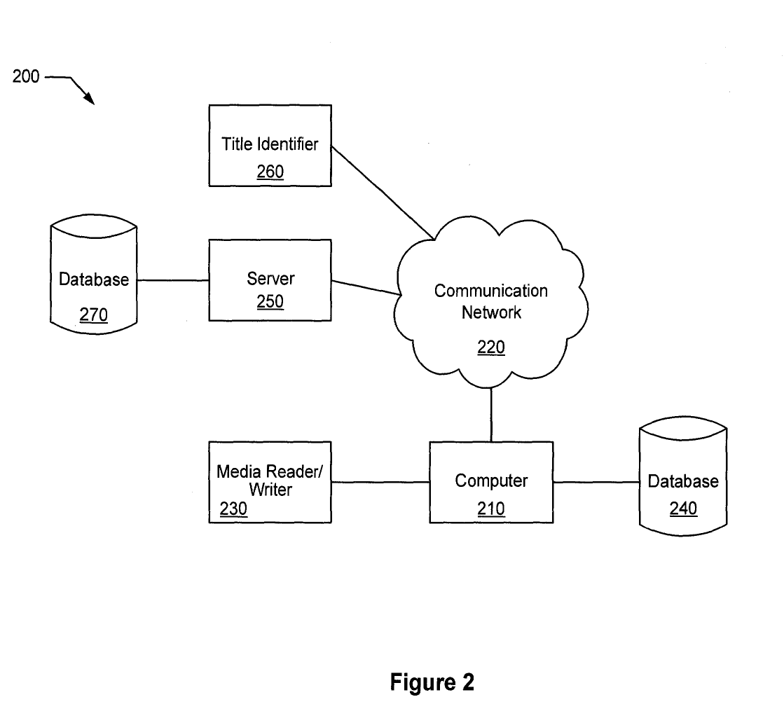

Turning to FIG. 2, a system 200 for rendering digital information of one fixed media onto another media using a database in accordance with one or more embodiments of the invention is shown. System 200 includes a computer 210 that is communicably coupled to a number of information sources via a communication network 220. User computer 210 may be any microprocessor based device known in the art including, but not limited to, a personal computer, a personal digital assistant, a laptop computer, a cellular telephone, an MP3 player, or the like. Based on the disclosure provided herein, one of ordinary skill in the art will recognize a variety of computers that may be used in accordance with one or more embodiments of the present invention. Computer 210 is associated with a media reader/writer 230 and a database 240. Database 240 may be composed of any computer readable medium. Database 240 may include a variety of digital information including content objects such as digital music and digital video files, as well as, software instructions executable by computer 210. In some cases, database 240 includes and Internet browser application. Database 240 may further include various software applications that when executed cause computer 210 to read and/or write information from one fixed media to another. As used herein, the phrase “computer readable medium” is used in its broadest sense to mean any medium that is readable by a computer. Thus, as just some examples, a computer readable medium may include a hard disk drive, an optical storage media, a random access memory, a magnetic tape media, a CD-ROM, a floppy diskette, a flash drive, combinations of the aforementioned, or the like. Based on the disclosure provided herein, one of ordinary skill in the art will recognize a number of media that may be used as a computer readable medium to implement one or more embodiments of the invention. The aforementioned Internet browser may be any application that allows a user to access one or more Internet sites via user computer 210. The fixed media reader and/or writer 230 may be any device capable of reading and/or writing digital information. As just some examples, media reader/writer 230 may be a CD reader/writer or a DVD reader/writer. Based on the disclosure provided herein, one of ordinary skill in the art will recognize a variety of media reader and/or media writer devices that may be used in accordance with one or more embodiments of the present invention.

Communication network 220 may be any network capable of allowing communications via one or more connected devices to one or more other connected devices. Thus, communication network 220 may be the Internet, a virtual private network, a local area network, a wide area network, a public switched telephone network, a cellular telephone network, combinations of the aforementioned, or the like. Further, the aforementioned connected devices may be, but are not limited to, computers, CD or DVD players, and/or the like.

System 200 may also include a digital information server 250 that is associated with a computer readable medium 244 including instructions executable by server 250 and/or user computer 210 to serve one or more applications for copying digital information contained in one fixed media to another. System 200 may further include another computer readable medium 270 including instructions executable to serve one or more Internet websites allowing system 200 to obtain the title of the first fixed media and/or digital information content of the first fixed media. Server 250 may be any processor based device that is capable of receiving information via communication network 220 from one area of system 200 and providing such information or a derivative thereof to another area of system 200. It should be noted that computer readable medium 244 and computer readable medium 270 may be included on the same computer readable medium or distributed across two or more computer readable media.

Computer readable medium 270 may include a database. The aforementioned database may include any schema categorizing digital information corresponding to a number of generally available fixed content. Based on the disclosure provided herein, one of ordinary skill in the art will recognize that the database may be implemented using various technologies known in the art including, but not limited to, computer technologies, database technologies, and/or search engine technologies. The aforementioned database may be accessible via the Internet. Thus, as just some examples, the database may be that of various commercially recognizable companies including, but not limited to, iTunes® store, Napster®, Rhapsody®, and the like.

System 200 may further include a title identification system 260 that is communicably coupled to communication network 220. Title identification system 260 may be any system that is capable of obtaining and/or using a portion of the information from the first fixed media and identifying the title and/or the digital information content of the first fixed media. Thus, as just one example, title identification system 260 may use CDDB or CD-text to determine the title of an audio CD. Based on the disclosure provided herein, one of ordinary skill in the art will recognize that title identification system 260 may be implemented using alternative technologies. Further, one of ordinary skill in the art will recognize that title identification system 260 may be implemented as part of server 250.

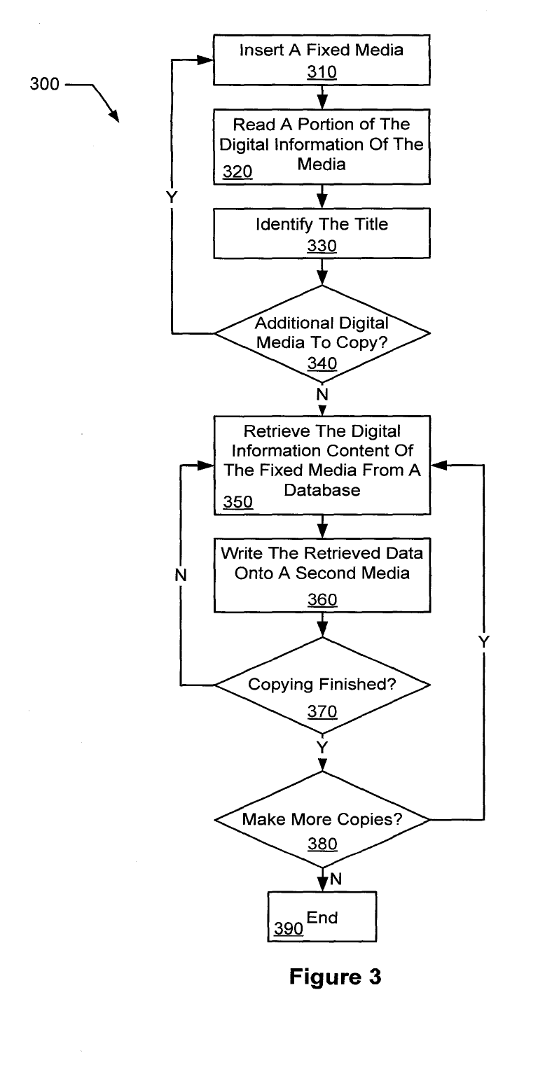

FIG. 3 is a flow diagram 300 depicting a method in accordance with other embodiments of the invention for copying digital information of one fixed media onto another media in accordance with various embodiments of the invention. Following flow diagram 300, a first fixed media to be copied is inserted by a user (block 310). After the first fixed media is inserted (block 310), computer 210 or server 250 reads a portion of the digital information contained in the first fixed media (block 320). Such information may include, for example, calculating unique ID, for example, based on the track duration information stored in the table-of-contents of the audio CD. Based on the disclosure provided herein, one of ordinary skill in the art may recognize a variety of information that may be used to identify the title of the first fixed media in accordance with one or more embodiments of the invention.

Then, computer 210 or server 250 accesses database 260 to identify the title of the first fixed media (block 330) using the information obtained in block 320. Once the title of the first fixed media has been identified (block 330), a query is made to the user to determine whether other fixed media is to be copied (block 340). In some embodiments of the invention, this process (blocks 310-340) is repeated until all the desired fixed media to be copied have been identified. In some embodiments, after identifying all the desired fixed media to be copied, computer 210 or server 250 retrieves or downloads digital information content of the fixed media to be copied (block 350) and writes the information onto another media (block 360). It should be appreciated that systems and methods of the invention include repeating partial information retrieval (block 350) and writing (block 360) until all the digital information content of the first fixed media is copied (block 370). Alternatively, systems and methods of the invention also include retrieving all the digital information (block 350) prior to writing the digital information onto another media (block 360). Still other embodiments of the invention include retrieving the digital information (block 350) while substantially concurrently writing the digital information onto anther media (block 360). After the digital information content of the first fixed media is copied onto another media, methods and systems of the invention also allow making more than one copy of digital information content of the first fixed media (block 380).

Based on the foregoing discussion, it should be evident that one or more embodiments of the invention may be used to copy digital information content of one fixed media to another media using the digital information obtained from a database rather than directly from the first fixed media. As other examples, embodiments of the invention may be used to copy digital information contents of a plurality of fixed media non-sequentially. Further, one or more embodiments of the invention may be utilized to make a plurality copies of digital information content of the first fixed media. Further, one or more embodiments of the invention may be modified to copy only a desired portion of digital information content of the first fixed media. It will be appreciated that use of one or more of the aforementioned embodiments may be used to make copying of the first fixed media easier and more reliable.

Based on the disclosure provided herein, one of ordinary skill in the art will recognize a myriad of advantages that may be achieved through use of one or more embodiments of the present invention. For example, higher speed and/or more accurate copying of fixed media may be achieved. In various cases, ripping software in accordance with one or more embodiments of the present invention transfers an identification from a CD or DVD to an online music or video store (e.g., iTunes™) and then the user can download individual songs/movies/TV show episodes of the identified CDs/DVDs from the online music or video store. The music or video store can either offer these downloads free of charge or for a discounted price (e.g. ten cents per song instead of the usual one dollar). Again, based on the disclosure provided herein, one of ordinary skill in the art will recognize other advantages that may be achieved in relation to different embodiments of the present invention.

In conclusion, the invention provides novel systems, devices, methods and arrangements for copying digital information content of a fixed media. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for rendering digital information contained on a fixed media to receiving media comprising:
accessing a portion of digital information contained on the fixed media, wherein the digital information includes a content object and an identification;
extracting the identification from the digital information;
based at least in part on the identification, accessing the content object from a database; and
rendering the content object to the receiving media.

2. The method of claim 1, wherein the identification includes information selected from a group consisting of: a title, an author, and an artist's name.

3. The method of claim 1, wherein the database is located on a server remote from the fixed media.

4. The method of claim 3, wherein the remote server is accessed via the Internet.

5. The method of claim 1, wherein the fixed media is selected from a group consisting of: a compact disc, and a digital versatile disc.

6. The method of claim 1, wherein the identification is determined from a portion of the digital information by comparing the portion of digital information with an identification database.

7. The method of claim 6, wherein the identification database is selected from a group consisting of: a compact disk database (CDDB), and a CD-Text standard.

8. The method of claim 1, wherein the receiving media is a portable media player.

9. The method of claim 1, wherein the identification includes an indicator of whether the fixed media is an original media, and wherein the original media serves as a license for accessing the database.

10. A method for writing digital information contained on a fixed media to a receiving media comprising:
obtaining a portion of the digital information contained in the first fixed media to determine the digital information content of the first fixed media;
obtaining the digital information content of the first fixed media from a remote database; and
writing the digital information content of the first fixed media to the second fixed media using the digital information obtained from the remote database.

11. The method of claim 10, wherein obtaining the digital information content of the first fixed media from the remote database comprises obtaining the entire digital information content of the first fixed media from the remote server prior to writing the digital information content onto the second fixed media.

12. The method of claim 10, wherein obtaining the digital information content of the first fixed media from the remote database comprises obtaining a partial digital information content of the first fixed media from the remote database, and wherein said method comprises repeating the process of obtaining the partial digital information content of the first fixed media from a remote database and writing the obtained partial digital information content onto the second fixed media until the entire digital information content of the first fixed media is written onto the second fixed media.

13. The method of claim 10, wherein obtaining the digital information content of the first fixed media from the remote database and writing the digital information content onto the second fixed media are performed concurrently.

14. A computer readable medium, wherein said computer readable medium comprises instructions executable by a computer to:
access a portion of digital information contained on a fixed media, wherein the digital information includes a content object and an identification;
extract the identification from the digital information;
based at least in part on the identification, access the content object from a database; and
render the content object to a receiving media.

15. The computer readable medium of claim 14, wherein the identification includes an indicator of whether the fixed media is an original media, and wherein the original media serves as a license for accessing the database.

16. The computer readable medium of claim 14, wherein the computer readable medium further includes instructions executable by the computer to determine the digital information content of the fixed media by comparing the portion of digital information with another database.

17. The method of claim 14, wherein said computer readable medium further includes instructions executable by the computer to obtain the digital information content of the first fixed media via the Internet.

18. A system for copying digital information content of a first fixed media to a second fixed media, said system comprising:
a computer; and
a computer readable medium accessible to the computer and including instructions executable by the computer to:
obtain a portion of digital information contained in a first fixed media to determine the digital information content of the first fixed media;
obtain the digital information content of the first fixed media from a database; and
render the digital information content of the first fixed media to the second fixed media using the digital information obtained from the database.

19. The system of claim 18, wherein said computer readable medium further comprises instructions executable by the computer to determine the digital information content of the first fixed media by comparing the portion of digital information with another database.

20. The system of claim 18, wherein said computer readable medium further comprises instructions executable by the computer to obtain the digital information content of the first fixed media via the Internet.
